(19) United States
(12) Patent Application Publication
(10) Pub. No.: US 2006/0267871 A1
(43) Pub. Date: Nov. 30, 2006

(54) Moving picture processing method and apparatus thereof

(75) Inventors: Hwa-seok Seong, Suwon-si (KR); Ho-seop Lee, Seoul (KR); Jong-sul Min, Hwaseong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/341,427

(22) Filed: Jan. 30, 2006

(30) Foreign Application Priority Data
May 31, 2005 (KR) 2005-0046451

(51) Int. Cl. G09G 3/28

(52) U.S. Cl. 345/63

(57) ABSTRACT

Disclosed are a moving picture processing method and an apparatus thereof. The moving picture processing apparatus includes a light emitting center calculator for calculating a light emitting center point for each of the sub-fields. A motion estimator detects a motion vector of a correspondent pixel using field data in a memory. A motion compensation luminance calculator calculates a motion compensation luminance for each of the sub-fields at a location of a correspondent pixel using the motion vector. An integral luminance calculator calculates a cumulative sum of predetermined luminance weights of sub-fields required to emit. A linear luminance calculator calculates a cumulative sum of predetermined luminance weights. A light emission selector determines presence/absence of light emission starting from a sub-field having the largest luminance weight, using the motion compensation luminance, integral luminance, linear luminance and luminance weight.

This application claims benefit under 35 U.S.C. § 119(a) from Korean Patent Application No. 2005-46451, filed on May 31, 2005, the entire disclosure of which is hereby incorporated by reference.

### BACKGROUND OF THE INVENTION

1. Field of the Invention

The present invention relates to a moving picture processing method and an apparatus thereof. More particularly, the present invention relates to a moving picture processing method and an apparatus thereof in accordance with an approach of dividing one field into a plurality of sub-fields comprised of luminance weights that are different from each other, and selectively combining a presence/absence of light emission for each of the divided sub-fields.

2. Description of the Related Art

Luminance refers to a measure of brightness of a light radiated from display screens of televisions, computers, or the likes. In particularly, luminance refers to an intensity of visual stimulation defined to be relatively well adapted to subjective brightness to which human beings respond.

FIG. 1 is a block diagram illustrating a configuration of a conventional moving picture processing apparatus. The conventional moving picture processing apparatus includes a motion estimator 10, a motion compensation luminance calculator 20, an integral luminance calculator 30 and a light emission selector 40.

Here, the motion estimator 10 detects a motion vector using Nth and (N−1)th frame data stored in a frame memory (not shown), and then outputs the motion vector to the motion compensation luminance calculator 20 and the integral luminance calculator 30.

The motion compensation luminance calculator 20 calculates a motion compensation luminance at a location of a processing object pixel for each sub-field using a motion vector output from the motion estimator 10, and then outputs the motion compensation luminance to the light emission selector 40.

The integral luminance calculator 30 receives the motion vector from the motion estimator 10 and then retrieves the motion vector from the location of a processing object pixel for each sub-field. Thereafter, the integral luminance calculator 30 calculates an integral luminance accumulated in human sight along the motion vector during one frame period and then outputs the calculated integral luminance to the light emission selector 40.

The light emission selector 40 selects a presence/absence of light emission of a processing object pixel for each sub-field by comparing a motion compensation luminance and an integral luminance, respectively calculated from the motion compensation luminance calculator 20 and the integral luminance calculator 30.

Since an operation principle of the motion estimator 10, motion compensation luminance calculator 20, integral luminance calculator 30 and light emission selector 40, as conventional components which are disclosed in Japanese Laid-open Publication No. 2003-177696 and Korean Patent Application No. 10-2001-7009316, is a technical configuration known by those skilled in the art, the detailed description thereof is omitted for clarity and conciseness.

In a conventional moving picture processing apparatus, light emission quantity to be recognized by human sight is estimated through the integral luminance calculator 30 using a motion vector at the location of each sub-field. The light emission selector 40 then determines presence/absence of light emission for each sub-field such that the foregoing integral luminance and motion compensation luminance correspond to each other, thereby preventing a generation of pseudo outlines when processing moving pictures.

In such a conventional moving picture processing apparatus, a method is used in which the light emission selector 40 selects presence/absence of light emission for each sub-field in an order from sub-fields having the smallest luminance weight to sub-fields having the largest luminance weight. This selection makes displaying precise luminance difficult.

The method for selecting light emission according to the related art will be described with reference to Table 1.

TABLE 1

| | | | | | | | | | | | SUM OF |
|---|---|---|---|---|---|---|---|---|---|---|---|
| | SUBFIELD | | | | | | | | | | LUMINANCE |
| | SF1 | SF2 | SF3 | SF4 | SF5 | SF6 | SF7 | SF8 | SF9 | SF10 | WEIGHTS |
| LUMINANCE | 1 | 2 | 4 | 8 | 16 | 24 | 32 | 44 | 56 | 68 | |
| WEIGHT | | | | | | | | | | | |
| SELECTION | ON | ON | ON | ON | ON | | | | | | 31 |
| IN | | | | | | | | | | | |
| INCREASING | | | | | | | | | | | |
| DIRECTION | | | | | | | | | | | |
| SELECTION | | | | | ON | ON | | | | | 40 |
| IN | | | | | | | | | | | |
| DECREASING | | | | | | | | | | | |
| DIRECTION | | | | | | | | | | | |

Table 1 illustrates a method for selecting light emission when displaying a luminance of “40” is required in a driving system having 10 sub-fields whose luminance weights are “1, 2, 4, 8, 16, 24, 32, 44, 56 and 68,” respectively.

In Table 1, light emitting states of the respective sub-fields are shown in which selections of presence/absence of light emission for each sub-field are performed in an increasing direction of luminance weights, and selections of presence/absence of light emission for each sub-field are performed in a decreasing direction of luminance weights.

When presence/absence of light emission for each sub-field is selected in the decreasing direction of luminance weights, the luminance required to display (“40” in Table 1) and the sum of the luminance weights of the sub-fields selected as light emission (16+24=40) become equal.

However, when presence/absence of light emission for each sub-field is selected in the increasing direction of luminance weights, five consecutive sub-fields emit light, and the sum (1+2+4+8+16) of the luminance weights of the sub-fields selected as light emission is “31”, which means that the sum of the luminance weights is different from the luminance required to display (“40” in Table 1).

Therefore, in the moving picture processing apparatus, a method is used for selecting presence/absence of light emission for each sub-field in an order from sub-fields having the largest luminance weight to sub-fields having the smallest luminance weight. However, such a conventional moving picture processing apparatus has several problems.

Some of these problems will be described with reference to Table 2.

TABLE 2

| | | | | | | | | | | | SUM OF |
|---|---|---|---|---|---|---|---|---|---|---|---|
| | SUBFIELD | | | | | | | | | | LUMINANCE |
| | SF1 | SF2 | SF3 | SF4 | SF5 | SF6 | SF7 | SF8 | SF9 | SF10 | WEIGHTS |
| LUMINANCE | 1 | 2 | 4 | 8 | 16 | 24 | 32 | 44 | 56 | 68 | |
| WEIGHT | | | | | | | | | | | |
| SELECTION | ON | ON | | | ON | ON | | | | | 43 |
| IN | | | | | | | | | | | |
| INCREASING | | | | | | | | | | | |
| DIRECTION | | | | | | | | | | | |
| SELECTION | | | | | | | | ON | | | 44 |
| IN | | | | | | | | | | | |
| DECREASING | | | | | | | | | | | |
| DIRECTION | | | | | | | | | | | |

Table 2 shows a light emitting pattern using a method for selecting sub-fields of a conventional moving picture processing apparatus when displaying luminances of “43” and “44” are required when a motion vector is “0”.

Since the motion vector is “0”, a compensation luminance is equal to the luminance required to display. If light emitting states are calculated by a luminance based on the method for selecting sub-fields of a conventional moving picture processing apparatus, four sub-fields are selected as light emitting states for the luminance “43”, and one sub-field is selected as a light emitting state for the luminance “44.”

In Table 2, although the 8th sub-field is in a light emitting state, for example, with luminance of “44,” the quantity of light emitted due to residual lifetime of phosphors remains even to the light emission time of the 9th sub-field.

Human sight recognizes not only the quantity of light emitted in sub-fields being in light emitting states, but also the quantity of light emitted due to residual lifetime of phosphors. As a result, a luminance, which human beings practically respond to, is increased as the number of sub-fields emitting light to display correspond to a luminance.

Thus, even though the luminance of “43” is smaller than the luminance of “44”, the recognizable luminance for the luminance of “43,” having more light emitting sub-fields than those of the luminance of “44,” becomes larger than the recognizable luminance for the luminance of “44”. As a result, luminance reversal is generated.

Although a method for selecting presence/absence of light emission for each sub-field in a decreasing direction of luminance weights is used, there is a problem of the luminance reversal.

The problem the method of selecting presence/absence of light emission for each sub-field in a decreasing direction of luminance weights will be described below.

In general plasma TVs comprise an analog to digital (A/D) process, an inverse gamma correcting process for adapting linear luminance characteristics of the plasma TVs to luminance characteristics of broadcasting transmission signals, and an error diffusing and dithering process for correcting decimal part data produced in a gamma correction.

Further, in order to visually reduce dot patterns produced in an error diffusing and dithering process, error diffusion coefficients and dither coefficients, each of which have a different time and space, are generally used.

However, in a still moving picture not having motion due to a mixing of noise in the A/D process and use of a different coefficient for each field in the error diffusing and dithering process, the luminance of a correspondent pixel is changed. For example, when the luminance of “43” in the Nth frame is changed into the luminance of “44” in the (N+1)th frame due to the mixing of noise, a central axis of light emission is changed from the center to the rear end of a field. As a result, flickers are produced.

The simplest method for reducing such flickers is to select presence/absence of light emission for each sub-field in an order from sub-fields having the smallest luminance weight to sub-fields having the largest luminance weight. However, such method, as described above, is not a preferred solution.

Consequently, when a method for selecting presence/absence of light emission for each sub-field in a decreasing direction of luminance weights is used, an additional problem in the discharge defect of display panels exists. Such problem will be described in detail with reference to Table 3.

TABLE 3

| | | | | | | | | | | | SUM OF |
|---|---|---|---|---|---|---|---|---|---|---|---|
| | SUBFIELD | | | | | | | | | | LUMINANCE |
| | SF1 | SF2 | SF3 | SF4 | SF5 | SF6 | SF7 | SF8 | SF9 | SF10 | WEIGHTS |
| LUMINANCE | 1 | 2 | 4 | 8 | 16 | 24 | 32 | 44 | 56 | 68 | |
| WEIGHT | | | | | | | | | | | |
| SELECTION | ON | ON | ON | | ON | ON | | | | | 47 |
| IN | | | | | | | | | | | |
| INCREASING | | | | | | | | | | | |
| DIRECTION | | | | | | | | | | | |
| SELECTION | ON | ON | | | | | | ON | | | 47 |
| IN | | | | | | | | | | | |
| DECREASING | | | | | | | | | | | |
| DIRECTION | | | | | | | | | | | |

Table 3 shows an example in which a luminance of “47” is displayed based on a method for selecting presence/absence of light emission for each sub-field in a conventional moving picture processing apparatus, assuming that no motion is included in a moving picture.

Table 3 shows both cases in which the presence/absence of light emission for each sub-field are performed in an increasing direction of luminance weights is selected, and that presence/absence of light emission for each sub-field are performed in a decreasing direction of luminance weights is selected.

In selecting a presence/absence of light emission for each sub-field in an increasing direction of luminance weights, “SF1, SF2, SF3, SF5 and SF6” are in light emitting states, and “SF4” is in a non-light emitting state. Among sub-fields being in light emitting states, “SF2, SF3 and SF6” can easily be in light emitting states because a recording pulse is applied to a panel in a state when the previous sub-fields of the respective sub-fields are in light emitting states. As a result, wall charges are formed within display cells.

On the other hand, when selecting presence/absence of light emission for each sub-field in a decreasing direction of luminance weights, only “SF1, SF2 and SF8” are in light emitting states. Since the sub-field of “SF1” has already been discharged, the sub-field of “SF2” can easily be in a light emitting state. However, in the sub-field of “SF8”, discharge is difficult to sustain because the sub-fields of “SF3” to “SF7” are in non-light emitting states. As a result, wall charges disappear, although discharge should be generated by a recording pulse.

A problem, which exists when a performance of reducing pseudo outlines in moving pictures is degraded, will be described with reference to Tables 4 and 5.

TABLE 4

| | | | | | | | | | | SUM OF LUMINANCE |
|---|---|---|---|---|---|---|---|---|---|---|
| SF1 | SF2 | SF3 | SF4 | SF5 | SF6 | SF7 | SF8 | SF9 | SF10 | WEIGHTS |
| 1 | 2 | 4 | 8 | 16 | 24 | 32 | 44 | 56 | 68 | |
| | | ON | | ON | ON | ON | | | | 76 |
| ON | | ON | | ON | ON | ON | | | | 77 |
| | ON | ON | | ON | ON | ON | | | | 78 |
| ON | ON | ON | | ON | ON | ON | | | | 79 |
| | | | ON | ON | ON | ON | | | | 80 |
| ON | | | ON | ON | ON | ON | | | | 81 |
| | ON | | ON | ON | ON | ON | | | | 82 |
| ON | ON | | ON | ON | ON | ON | | | | 83 |

TABLE 5

| | | | | | | | | | | SUM OF LUMINANCE |
|---|---|---|---|---|---|---|---|---|---|---|
| SF1 | SF2 | SF3 | SF4 | SF5 | SF6 | SF7 | SF8 | SF9 | SF10 | WEIGHTS |
| 1 | 2 | 4 | 8 | 16 | 24 | 32 | 44 | 56 | 68 | |
| | | | | | | ON | ON | | | 76 |
| ON | | | | | | ON | ON | | | 77 |
| | ON | | | | | ON | ON | | | 78 |
| ON | ON | | | | | ON | ON | | | 79 |
| | | | | | ON | | | ON | | 80 |
| ON | | | | | ON | | | ON | | 81 |
| | ON | | | | ON | | | ON | | 82 |
| ON | ON | | | | ON | | | ON | | 83 |

Table 4 shows a process of selecting presence/absence of light emission for each sub-field in an increasing direction of luminance weights, and Table 5 shows a process of selecting presence/absence of light emission for each sub-field in a decreasing direction of luminance weights.

In light emitting patterns shown in Table 4, the light emitting patterns between adjacent luminances are similar to each other. In light emitting patterns shown in Table 5, the light emitting patterns between adjacent luminances are different from each other.

Since frequencies of sub-fields, being in the same light emitting states between adjacent luminances, become larger when light emitting patterns between adjacent luminances are similar to each other, compensating errors are generated between the luminances, even though sub-field interpolation is performed only at a light emitting center portion. On the other hand, since frequencies of sub-fields, being in the same light emitting states between adjacent luminances, become smaller when light emitting patterns between adjacent luminances are different from each other, the errors between the luminances cannot be compensated.

Therefore, a conventional moving picture processing apparatus for determining light emitting states from sub-fields having the largest luminance weight to sub-fields having the smallest luminance weight, propagates luminance errors in accordance with integral areas of human sight, even if motion compensation is performed. Accordingly, the performance of reducing false outlines (hereinafter, pseudo outlines) shown in moving pictures, depending on a direction and a speed of motion, is degraded.

### SUMMARY OF THE INVENTION

An aspect of embodiments of the present invention is to address at least the above problems and/or disadvantages and to provide at least the advantages described below. Accordingly, an aspect of embodiments of the present invention is to provide a moving picture processing method and an apparatus thereof, wherein pseudo outlines and motion blurs shown in moving pictures, depending on a direction and a speed of motion, are removed when reproducing the moving pictures so that the moving picture quality of a moving picture processing apparatus can be improved, and more precise gray level displays are possible.

In order to achieve the above-mentioned object, there is provided a moving picture processing apparatus including a light emitting center calculator for calculating a light emitting center point for each of the sub-fields. A motion estimator detects a motion vector of a correspondent pixel using field data in a memory. A motion compensation luminance calculator calculates a motion compensation luminance for each of the sub-fields at the location of a correspondent pixel using the motion vector. An integral luminance calculator calculates the cumulative sum of predetermined luminance weights of sub-fields required to emit light in accordance with an order that the luminance weight for each of the sub-fields is decreased. A linear luminance calculator calculates the cumulative sum of predetermined luminance weights in accordance with an order that the luminance weight for each of the sub-fields is decreased. A light emission selector determines presence/absence of light emission starting from a sub-field having the largest luminance weight, using the motion compensation luminance, integral luminance, linear luminance and luminance weight.

In an exemplary implementation, the light emission selector determines a correspondent sub-field as light emission when the difference value between the motion compensation luminance and the integral luminance is not smaller than the luminance weight of the correspondent sub-field, but larger than the linear luminance.

In an exemplary implementation, the apparatus further includes an inverse gamma corrector that corrects an input moving picture signal to be an output signal having a characteristic of an inverse gamma curve.

In an exemplary implementation, the apparatus further includes an APL calculator that calculates a mean luminance from an output signal of the inverse gamma corrector during one field, and calculating the number of sustain pulses for each sub-field, then outputting the number of sustain pulses.

In an exemplary implementation, the apparatus further includes a luminance corrector that limits the motion compensation luminance to a usable luminance based on predetermined usable luminances, and compensating a luminance error generated between the motion compensation luminance and the usable luminance, then outputting the compensated luminance error.

In an exemplary implementation, the compensation of the luminance error is executed by any one of an error diffusing method or a dither method.

In an exemplary implementation, the light emission selector indicates “1” when the light emission of the sub-field is required, and “0” when the light emission of the sub-field is not required.

In order to achieve another object, there is provided a moving picture processing method according to an exemplary implementation of the present invention that includes calculating a light emitting center point for each of the sub-fields. A motion vector of a correspondent pixel is detected using field data in a memory. A motion compensation luminance for each of the sub-fields is calculated at the location of a correspondent pixel using the motion vector. An integral luminance is calculated, being the cumulative sum of predetermined luminance weights of sub-fields required to emit light in accordance with an order that the luminance weight for each of the sub-fields is decreased. A linear luminance is calculated, being the cumulative sum of predetermined luminance weights in accordance with an order that the luminance weight for each of the sub-fields is decreased. Presence/absence of light emission is determined starting from a sub-field having the largest luminance weight, using the motion compensation luminance, integral luminance, linear luminance and luminance weight.

In an exemplary implementation, the determining of presence/absence of light emission determines a correspondent sub-field as light emission when the difference value between the motion compensation luminance and the integral luminance is not smaller than the luminance weight of the correspondent sub-field, but larger than the linear luminance.

In an exemplary implementation, the method further includes correcting an input moving picture signal to be an output signal having a characteristic of an inverse gamma curve before the calculating of the light emitting center point.

In an exemplary implementation, the method further includes calculating a mean luminance from an output signal of the inverse gamma corrector during one field, and calculating the number of sustain pulses for each sub-field.

In an exemplary implementation, the method further includes limiting the motion compensation luminance to a usable luminance based on predetermined usable luminances, and compensating a luminance error generated between the motion compensation luminance and the usable luminance, then outputting the compensated luminance error.

In an exemplary implementation, the correcting of the luminance error is executed by any one of an error diffusing method or a dither method.

In an exemplary implementation, the determining of presence/absence of light emission indicates “1” when the light emission of the sub-field is required, and “0” when the light emission of the sub-field is not required.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram illustrating a configuration of a moving picture processing apparatus according to a related art;

FIG. 2 is a block diagram illustrating a configuration of a moving picture processing apparatus according to an exemplary embodiment of the present invention;

FIG. 3 is a waveform diagram showing a driving signal for display in a moving picture processing apparatus according to an exemplary embodiment of the present invention;

FIG. 4 is a view illustrating a linear luminance operation method and an order of selection for presence/absence of light emission according to an exemplary embodiment of the present invention;

FIG. 5 is a view illustrating an operation characteristic of a luminance corrector according to an exemplary embodiment of the present invention; and

FIG. 6 is a view illustrating an operation principle of a luminance corrector according to an exemplary embodiment of the present invention.

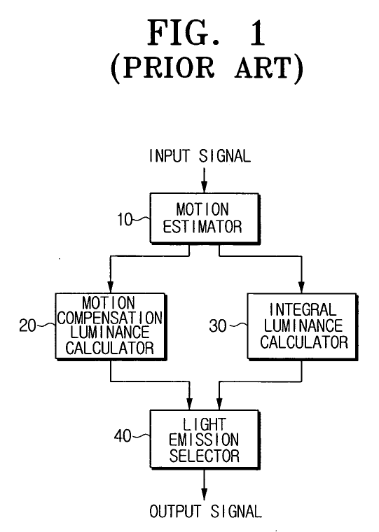

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of the well-known functions and constructions are omitted for clarity and conciseness.

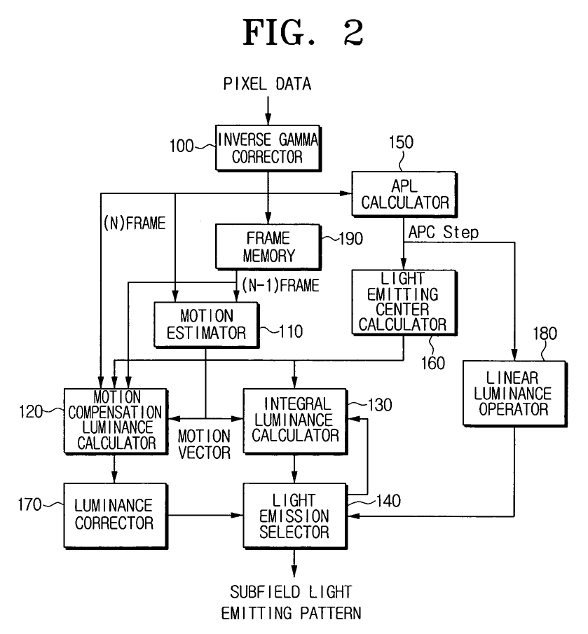

FIG. 2 is a block diagram illustrating a configuration of a moving picture processing apparatus according to an exemplary embodiment of the present invention. The moving picture processing apparatus according to an exemplary embodiment of the present invention includes an inverse gamma corrector 100, a motion estimator 110, a motion compensation luminance calculator 120, an integral luminance calculator 130, a light emission selector 140, an Average Picture Level (APL) calculator 150, a light emitting center calculator 160, a luminance corrector 170, a linear luminance operator 180 and a frame memory 190.

In the moving picture processing apparatus of the present invention, the inverse gamma corrector 100 includes an inverse gamma converter (not shown) and an error diffuser (not shown). The inverse gamma converter corrects an input and output characteristic, between an input moving picture signal and an output signal of the inverse gamma corrector 100, to become an inverse gamma curve.

The error diffuser performs an error diffusing process with respect to lower four bits in the output signal of the inverse gamma corrector 100 and then outputs the signal.

The frame memory 190 stores frame data for each frame input from the inverse gamma corrector 100.

The motion estimator 110 detects motion vectors using Nth and (N−1)th frame data stored in the frame memory 190, and then outputs the motion vectors to the motion compensation luminance calculator 120 and the integral luminance calculator 130.

The motion compensation luminance calculator 120 calculates a motion compensation luminance for each sub-field using a motion vector input from the motion estimator 110 and frame data stored in the frame memory 190, and then outputs the motion compensation luminance to the luminance corrector 170.

The APL calculator 150 calculates mean luminance data during one field period from the foregoing output signal of the inverse gamma corrector 100 and calculates a number of sustain pulses possible to display by each sub-field, then outputs the sustain pulses.

The light emitting center calculator 160 calculates a light emitting center point for each sub-field based on the number of input sustain pulses and then outputs the light emitting center point.

The linear luminance calculator 180 calculates a luminance level possible to display using a light emitting pattern not having a non-light emitting sub-field, based on the number of input sustain pulses, and then outputs the luminance level.

The luminance corrector 170 limits a motion compensation luminance input based on predetermined available luminance levels to an available luminance level, and corrects a luminance error generated between the motion compensation luminance and the available luminance using a multi-level gradation method such as error diffusion or dithering, then outputs the corrected luminance error.

In an exemplary implementation, dithering refers to a technology used to approximately produce multi-level color moving pictures exceeding capability (resolution) of display devices or printers in computer graphics (CG). A technology of processing each area of a moving picture with a set of different level colors is mainly used in the dithering.

In black-and-white display devices or printers, an entire picture is shown as a specific level of gray, depending on a rate of black dots and white dots within an arbitrary area of a moving picture. In the same manner, an entire picture is shown as various levels of pink, depending on a rate of red dots and white dots within an arbitrary area of a moving picture in color display devices or printers. The dithering produces moving pictures similar to halftone images.

Such dithering is used to increase a true feeling of processing computer graphics in low resolution, and to make rough and jagged outlines or diagonals inconspicuous, which is referred to as a dither method.

Based on an input motion vector and a light emitting center point for each sub-field, the integral luminance calculator 130 calculates a quantity of light integrated during one field period along a motion vector from a light emitting center point for each sub-field and then outputs the quantity of light.

The light emission selector 140 determines a light emitting state of a current processing object sub-field, based on a linear luminance and then outputs the light emitting state.

Since an operation principle of the motion estimator 110, such as the motion compensation luminance calculator 120 and integral luminance calculator 130, in a moving picture processing apparatus according to an exemplary embodiment of the present invention is known by those skilled in the art, detailed descriptions thereof is omitted for clarity and conciseness.

The moving picture processing apparatus according to an exemplary embodiment of provides a display level corrector, a light emitting center calculator and a linear luminance operator.

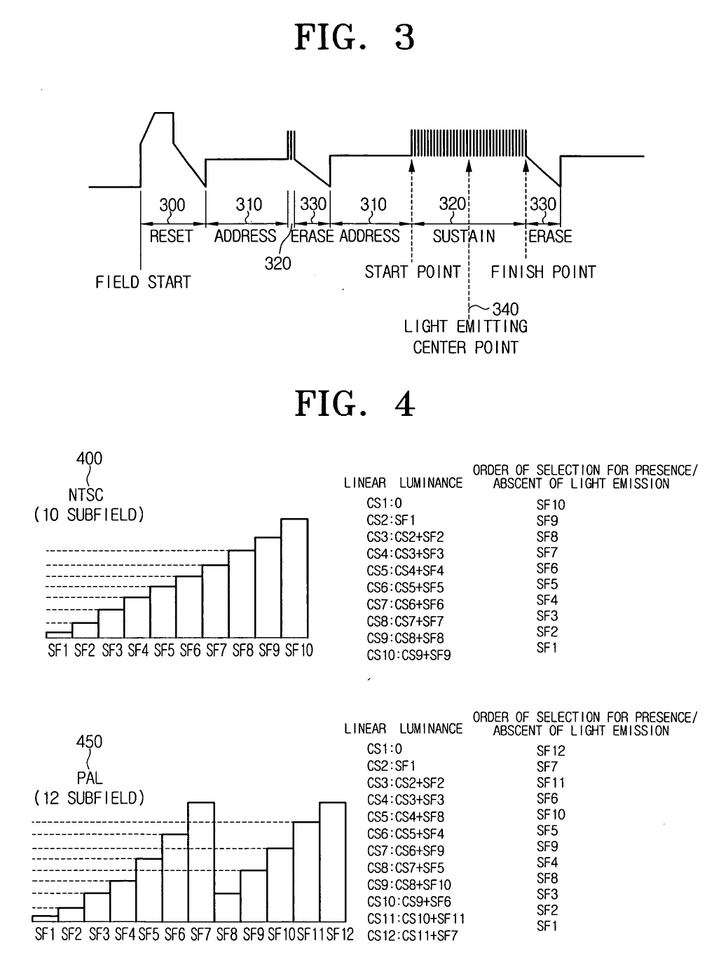

FIG. 3 is a waveform diagram showing a driving signal for display in a moving picture processing apparatus according to an exemplary embodiment of the present invention.

In an operation principle of the light emitting center 160, described with reference to FIG. 3, a display driving signal comprises a reset period 300 for resetting as an initial state by erasing previously produced wall charges, an address period 310 for scanning a recording pulse, a sustain period 320 for scanning a discharge sustain pulse and an erase period 330 for erasing.

In the sustain period 320, which is a discharge sustain period, human beings may respond to a luminance. The light emitting center calculator 160 calculates a center point 340 in a discharge sustain period for each sub-field based on a possible number of input sustain pulses to display by each sub-field, and then outputs the center point.

Here, the light emitting center point 340 for each sub-field becomes different depending on the number of sustain pulses possible to display in a current frame.

An operation principle of the linear luminance operator 180 in a moving picture processing apparatus according to an exemplary embodiment of the present invention will now be described in detail.

In a moving picture processing apparatus according to an exemplary embodiment of the present invention, an output of the linear luminance operator 180 is used as a comparative value for determining light emitting patterns in an order from sub-fields having the largest luminance weight to sub-fields having the smallest luminance weight.

The following Table 6 shows a light emitting pattern used in calculating a linear luminance.

TABLE 6

| | SF1 | SF2 | SF3 | SF4 | SF5 | SF6 | SF7 | SF8 | SF9 | SF10 |
|---|---|---|---|---|---|---|---|---|---|---|
| INDEX | 1 | 2 | 4 | 8 | 16 | 24 | 32 | 44 | 56 | 68 |
| 0 | 0 | 0 | 0 | 0 | 0 | 0 | 0 | 0 | 0 | 0 |
| 1 | 1 | 0 | 0 | 0 | 0 | 0 | 0 | 0 | 0 | 0 |
| 2 | 1 | 1 | 0 | 0 | 0 | 0 | 0 | 0 | 0 | 0 |
| 3 | 1 | 1 | 1 | 0 | 0 | 0 | 0 | 0 | 0 | 0 |
| 4 | 1 | 1 | 1 | 1 | 0 | 0 | 0 | 0 | 0 | 0 |
| 5 | 1 | 1 | 1 | 1 | 1 | 0 | 0 | 0 | 0 | 0 |
| 6 | 1 | 1 | 1 | 1 | 1 | 1 | 0 | 0 | 0 | 0 |
| 7 | 1 | 1 | 1 | 1 | 1 | 1 | 1 | 0 | 0 | 0 |
| 8 | 1 | 1 | 1 | 1 | 1 | 1 | 1 | 1 | 0 | 0 |
| 9 | 1 | 1 | 1 | 1 | 1 | 1 | 1 | 1 | 1 | 0 |
| 10 | 1 | 1 | 1 | 1 | 1 | 1 | 1 | 1 | 1 | 1 |

As shown in Table 6, a linear luminance is expressed as the sum of luminance weights of all the sub-fields previous to a correspondent sub-field. That is, the linear luminance is calculated in all the sub-fields previous to the correspondent sub-field in accordance with a reference based on a state with no non-light emitting sub-field.

Therefore, when the respective luminance weights of the sub-fields are “1, 2, 4, 8, 16, 24, 32, 44, 56 and 68,” the respective linear weights become “0, 1, 3, 7, 15, 31, 55, 87, 131, 187 and 255.”

FIG. 4 is a view illustrating a linear luminance operation method and an order of selection for presence/absence of light emission according to an exemplary embodiment of the present invention.

With reference to FIG. 4, a linear luminance operation method and an order of selecting presence/absence of light emission for each sub-field in a National Television System Committee (NTSC) mode having a frequency of 60 Hz, and a Phase Alternating Line (PAL) mode having a frequency of 50 Hz will be described below.

Referring to FIG. 4, an order of selecting presence/absence of light emission for each sub-field and a linear luminance operation method, in case of the NTSC mode 400, indicating 60 frames per second, are different from those in case of the PAL mode 450 indicating 50 frames per second.

In the NTSC mode 400 having a frequency of 60 Hz, the simple cumulative sum of luminance weights is obtained since sub-field weights are monotonously increasing.

However, in the PAL mode 450 having a frequency of 50 Hz, since two sub-fields having the largest luminance weights are divided to arrange at the center and the end of a frame to reduce flickers sensed by human sight, the order of arranging the luminance weights is different from the order in the NTSC mode 400.

In the PAL mode 450, after the order of a sub-field having luminance weights is rearranged in the form of monotonously increasing, which has luminance weights in order from sub-fields having the largest luminance weight to sub-fields having the smallest luminance weight, linear luminances are calculated. The presence/absence of light emission is selected for each sub-field starting from a sub-field having the largest luminance weight.

If a plurality of sub-fields, having the same luminance weights exists, the light emitting pattern is generated prior to the sub-field located at the end of the frame.

An operation principle of the light emission selector 140 according to an exemplary embodiment of the present invention will be described below.

In a moving picture processing apparatus according to an exemplary embodiment of the present invention, the light emission selector 140 determines a correspondent sub-field to emit light when the difference value between a motion compensation luminance and an integral luminance is not smaller than a luminance weight of the correspondent sub-field (condition 1), but larger than a linear luminance (condition 2).

That is, when the difference value between a motion compensation luminance and an integral luminance is smaller than a luminance weight of the correspondent sub-field (the case of not meeting condition 1), the light emission selector 140 does not determine a correspondent sub-field to emit light.

Also, when the difference value between a motion compensation luminance and an integral luminance is larger than a linear luminance (the case of not meeting condition 2), the light emission selector 140 does not determine a correspondent sub-field to emit light. That is, in an exemplary implementation of the present invention, a correspondent sub-field is selected as a light emitting state when the difference between a motion compensation luminance and an integral quantity of light is larger than a linear luminance.

Although the light emission selector 140 of the present invention determines presence/absence of light emission, starting from a sub-field having the largest luminance weight in the same manner as the conventional method, the light emission selector 140 simultaneously selects a sub-field as a light emitting state prior to a sub-field having a small luminance weight.

That is, the light emission selector 140 selects sub-fields as consecutively light emitting states in accordance with an order from sub-fields having the largest luminance weight to sub-fields having the smallest luminance weight.

A method of selecting presence/absence of light emission in a moving picture processing apparatus will be described using Table 7.

TABLE 7

| ORDER OF | | | | | | | | |
|---|---|---|---|---|---|---|---|---|
| SELECTION | | | | | | | | DECISION |
| FOR | | | | | | | | OF |
| PRESENCE/ | | | | | | | | PRESENCE/ |
| ABSENCE | SUB- | | | MOTION | | WHETHER | WHETHER | ABSENCE |
| OF LIGHT | FIELD | LUMINANCE | LINEAR | COMPENSATION | INTEGRAL | TO MEET | TO MEET | OF LIGHT |
| EMISSION | NUMBER | WEIGHT | LUMINANCE | LUMINANCE | LUMINANCE | CONDITION 1 | CONDITION 2 | EMISSION |
| 1 | SF10 | 68 | 187 | 80 | 0 | YES | NO | 0 |
| 2 | SF9 | 56 | 131 | 80 | 0 | YES | NO | 0 |
| 3 | SF8 | 44 | 87 | 80 | 0 | YES | NO | 0 |
| 4 | SF7 | 32 | 55 | 80 | 0 | YES | YES | 1 |
| 5 | SF6 | 24 | 31 | 80 | 32 | YES | YES | 1 |
| 6 | SF5 | 16 | 15 | 80 | 56 | YES | YES | 1 |
| 7 | SF4 | 8 | 7 | 80 | 72 | YES | YES | 1 |
| 8 | SF3 | 4 | 3 | 80 | 80 | NO | NO | 0 |
| 9 | SF2 | 2 | 1 | 80 | 80 | NO | NO | 0 |
| 10 | SF1 | 1 | 0 | 80 | 80 | NO | NO | 0 |

Table 7 shows an operation characteristic of the light emission selector 140 for a luminance of “80,” assuming that there is no motion of a moving picture. Since there is no motion of the moving picture, motion compensation luminances for all the sub-fields become “80,” which is a luminance at a location of a current processing object pixel.

In the sub-field of “SF10,” being a first object to determine presence/absence of light emission, an integral luminance becomes “0” because there is no sub-field selected as a light emitting state. Since condition 1 is met, but condition 2 is not met, the sub-field is determined as a non-light emitting state.

The sub-fields of “SF9,” being a second object to determine presence/absence of light emission and “SF8,” being a third object to determine presence/absence of light emission, are also determined as non-light emitting states, since condition 1 is met, but condition 2 is not met.

However, the sub-field of “SF7,” being a fourth object to determine presence/absence of light emission, is determined as a light emitting state since conditions 1 and 2 are met.

In the determined state of a presence/absence of light emission for each sub-field, after all the presence/absence of light emission in accordance with the rest of the sub-fields, down to the sub-field of “SF1,” are determined in the same manner, “SF7, SF6, SF5 and SF4” are determined as light emitting states.

Thus, in selecting a combination of sub-fields determined as light emitting states in accordance with a motion compensation luminance, by a method of selecting presence/absence of light emission according to an exemplary embodiment of the present invention, selection of presence/absence of light emission is executed in an order from sub-fields having the largest luminance weight to sub-fields having the smallest luminance weight in the same manner as the related art.

However, by the foregoing conditions 1 and 2, the combination of sub-fields selected as light emitting states is composed of a combination of sub-fields having small luminance weights as possible, and numbers of sub-fields selected as light emitting states are composed of a combination of consecutive sub-fields at the same time. As a result, the foregoing problems in the conventional moving picture processing apparatus can be solved.

However, in the foregoing exemplary embodiments, it is difficult to sustain the discharge of “SF4” because “SF1, SF2 and SF3” are in non-light emitting states in which electric charges have disappeared.

Accordingly, in a moving picture processing apparatus according to an exemplary embodiment of the present invention, a separate luminance corrector 170 is included to ensure margins for applying recording pulses.

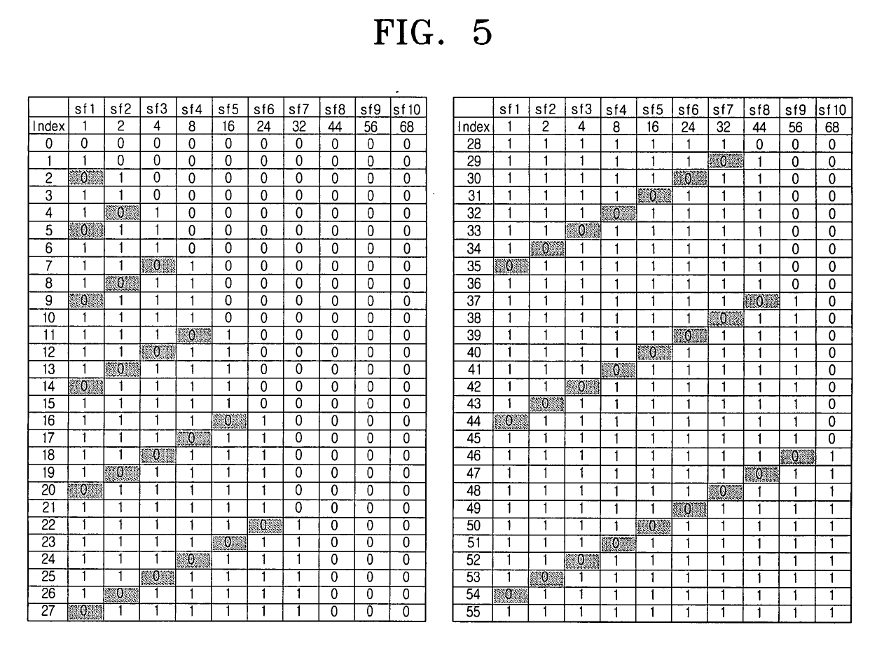

FIG. 5 is a view illustrating an operation characteristic of a luminance corrector according to an exemplary embodiment of the present invention.

With reference to an example of the light emitting states for each sub-field shown in FIG. 5, sub-fields that have luminance weights smaller than a sub-field having the largest luminance weight, among the sub-fields selected as light emitting states, none or one sub-field is selected as a non-light emitting state.

As such, although the kth sub-field is in a non-light emitting state after the (k−1)th sub-field emits light, the amount of wall charges disappeared is relatively small if the (k+1)th sub-field is in a light emitting state so that margins for applying recording pulses can be ensured.

The luminance corrector 170 uses luminances composed of light emitting patterns shown in FIG. 5 and converts other luminances into the luminances shown in FIG. 5.

Further, the luminance corrector 170 compensates luminance errors generated while converting into the luminances shown in FIG. 5 through a multi-level gradation method such as an error diffusing method or a dither method.

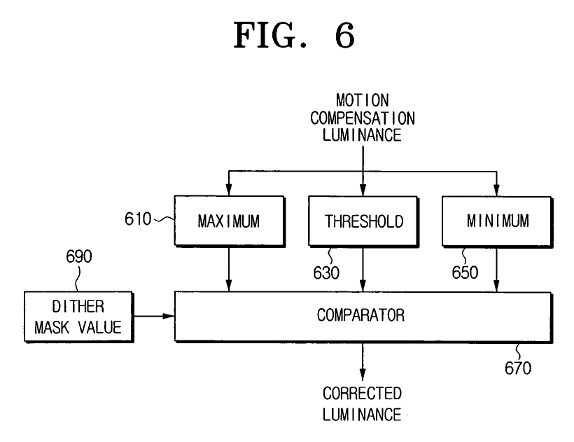

FIG. 6 is a view illustrating an operation principle of a luminance corrector according to an exemplary embodiment of the present invention.

An input motion compensation luminance is converted into a luminance for arbitrary use through a maximum value table 610, a minimum value table 650 and a threshold table 630.

In a comparator 670, a threshold and a dither mask value (MaskVal) 690 are compared with each other. As a result, if the threshold is larger than the dither mask value 690, a maximum value is output. If the threshold is equal to or smaller than the dither mask value 690, a minimum value is output.

The following Table 8 illustrates an operation principle of a luminance correction unit.

TABLE 8

| | | | | | | | | | | | | | |
|---|---|---|---|---|---|---|---|---|---|---|---|---|---|
| INPUT | 87 | 88 | 89 | 90 | 91 | 92 | 93 | 94 | 95 | 96 | 97 | 98 | 99 |
| LUMINANCE | | | | | | | | | | | | | |
| MAXIMUM | 99 | 99 | 99 | 99 | 99 | 99 | 99 | 99 | 99 | 99 | 99 | 99 | 107 |
| MINIMUM | 87 | 87 | 87 | 87 | 87 | 87 | 87 | 87 | 87 | 87 | 87 | 87 | 87 |
| THRESHOLD | 0 | 21 | 43 | 64 | 85 | 106 | 128 | 149 | 170 | 191 | 213 | 234 | 0 |

Table 8 shows a portion of the foregoing tables. In Table 8, usable luminances are “89, 99 and 107.”

In the maximum value table, the larger one of two usable luminances whose difference with an input luminance is the smallest, is stored, and the smaller one of the two usable luminances is stored in the minimum value table.

Assuming that relative locations of a minimum value and a maximum value are “0” and “S”, a threshold refers to a relative location of a luminance required to reproduce. The following Expression 1 is a formula for calculating the threshold.

$$Threshold = \frac{255 ( Input - Min )}{( Max - Min )} \qquad Expression 1$$

wherein “Input”, “Min” and “Max” denote an input luminance, a minimum value and a maximum value, respectively. For example, if an input luminance is “93”, the minimum value and the maximum value become the luminances of “87” and “99”, respectively, and the threshold of a luminance required to reproduce becomes “128” (the value of rounding off “127.5”) by the Expression 1.

Although a dither method is selected as a multi-level gradation method for correcting a luminance of a luminance corrector in an exemplary implementation of the present specification, an error diffusing method can be used, and dither masks different from each other by frame can also be used.

As described above, according to exemplary embodiments of the present invention, pseudo outlines and motion blurs shown in moving pictures, depending on a direction and a speed of motion, are removed when reproducing the moving pictures so that the moving picture quality of a moving picture processing apparatus can be improved. As a result, precise gray level displays are possible.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A moving picture processing apparatus comprising a field divided into a plurality of sub-fields, comprising a weight and displaying a set of pictures through a combination of light emission, the moving picture processing apparatus comprising:
a light emitting center calculator for calculating a light emitting center point for each of the sub-fields;
a motion estimator for detecting a motion vector of a correspondent pixel using field data in a memory;
a motion compensation luminance calculator for calculating a motion compensation luminance for each of the sub-fields at a location of a correspondent pixel using the motion vector;
an integral luminance calculator for calculating a cumulative sum of luminance weights of sub-fields required to emit light in accordance with an order that the luminance weight for each of the sub-fields is decreased;
a linear luminance calculator for calculating a cumulative sum of luminance weights in accordance with an order that the luminance weight for each of the sub-fields is decreased; and
a light emission selector for determining at least one of presence and absence of light emission starting from a sub-field having a largest luminance weight, using the motion compensation luminance, integral luminance, linear luminance and luminance weight.

2. The apparatus according to claim 1, wherein the light emission selector determines a correspondent sub-field as light emission when the difference value between the motion compensation luminance and the integral luminance is not smaller than the luminance weight of the correspondent sub-field, and is larger than the linear luminance.

3. The apparatus according to claim 1, further comprising an inverse gamma corrector for correcting an input moving picture signal to be an output signal, comprising a characteristic of an inverse gamma curve.

4. The apparatus according to claim 3, further comprising an Average Picture Level (APL) calculator for calculating a mean luminance from an output signal of the inverse gamma corrector during one field, calculating the number of sustain pulses for each sub-field, and outputting the number of sustain pulses.

5. The apparatus according to claim 1, further comprising a luminance corrector for limiting the motion compensation luminance to a usable luminance, based on usable luminances, and compensating a luminance error generated between the motion compensation luminance and the usable luminance, then outputting the compensated luminance error.

6. The apparatus according to claim 5, wherein the compensation of the luminance error is executed by an error diffusing method or a dither method.

7. The apparatus according to claim 1, wherein the light emission selector indicates “1” when the light emission of the sub-field is required, and “0” when the light emission of the sub-field is not required.

8. A moving picture processing method for dividing a field into a plurality of sub-fields, each sub-field comprising a weight and displaying a set of pictures through a combination of light emission, the moving picture processing method comprising:
calculating a light emitting center point for each of the sub-fields;
detecting a motion vector of a correspondent pixel using field data in a memory;
calculating a motion compensation luminance for each of the sub-fields at a location of the correspondent pixel using the motion vector;
calculating an integral luminance, the integral luminance comprising a cumulative sum of luminance weights of sub-fields required to emit light in accordance with an order that the luminance weight for each of the sub-fields is decreased;
calculating a linear luminance being a cumulative sum of luminance weights in accordance with an order that the luminance weight for each of the sub-fields is decreased; and
determining at least one of presence and absence of light emission starting from a sub-field having a largest luminance weight, using the motion compensation luminance, integral luminance, linear luminance and luminance weight.

9. The method according to claim 8, wherein the determining of at least one of presence and absence of the light emission comprises determining a correspondent sub-field as light emission when the difference value between the motion compensation luminance and the integral luminance is not smaller than the luminance weight of the correspondent sub-field, and is larger than the linear luminance.

10. The method according to claim 8, further comprising correcting an input moving picture signal to be an output signal comprising a characteristic of an inverse gamma curve before the calculating of the light emitting center point.

11. The method according to claim 10, further comprising calculating a mean luminance from an output signal of the inverse gamma corrector during one field, and calculating the number of sustain pulses for each sub-field.

12. The method according to claim 8, further comprising limiting the motion compensation luminance to a usable luminance based on usable luminances, compensating a luminance error generated between the motion compensation luminance and the usable luminance, and outputting the compensated luminance error.

13. The method according to claim 8, wherein the correcting of the luminance error comprises execution of an error diffusing method or a dither method.

14. The method according to claim 8, wherein the determining of the at least one of presence and absence of the light emission indicates “1” when the light emission of the sub-field is required, and “0” when the light emission of the sub-field is not required.
